(19) United States
(12) Patent Application Publication
(10) Pub. No.: US 2013/0180845 A1
(43) Pub. Date: Jul. 18, 2013

(54) FILTER FOR REMOVING MACRO-PARTICLES FROM A PLASMA BEAM

(71) Applicants: Xu Shi, Singapore (SG); Hao Wei, Singapore (SG)

(72) Inventors: Xu Shi, Singapore (SG); Hao Wei, Singapore (SG)

(73) Assignee: Nanofilm Technologies International Pte Ltd, Ayer Rajah Industrial Estate (SG)

(21) Appl. No.: 13/876,100

(22) PCT Filed: Sep. 30, 2011
(86) PCT No.: PCT/SG2011/000342

§ 371 Date: Mar. 26, 2013

(30) Foreign Application Priority Data
Oct. 1, 2010 (SG) 1016501.7

(51) Int. Cl. H01J 3/40; B01D 45/04

(52) U.S. Cl. CPC H01J 3/40; B01D 45/04
USPC 204/192.38; 55/462; 95/28; 55/424; 204/298.41

(57) ABSTRACT

A filter for filtering macro-particles from a plasma beam, having a bended duct for carriage of the plasma beam, the bended duct comprising an intermediate portion connected at one end to an inlet portion having a longitudinal axis disposed on an inlet plane and at another opposite end to an outlet portion having a longitudinal axis disposed on an outlet plane. The inlet portion allows the plasma beam containing macro-particles to travel toward the intermediate portion in an incident direction and the outlet portion allows the plasma beam to travel from the intermediate portion in an emergent direction. The intermediate portion is configured to deviate the incident direction to the emergent direction at an angle of more than 90° and thereby remove macro-particles from the plasma beam as it passes through the intermediate portion. The inlet plane and outlet plane are disposed at an offset angle from each other.

### FIELD OF INVENTION

The present invention generally relates to a filter for removing macro-particles from a plasma beam. The invention also relates to an arc deposition apparatus and a method for removing macro-particles from a plasma beam.

### BACKGROUND

Arc deposition techniques have been commonly used to produce super-hard coatings and nano-composite coatings. However, arc deposition techniques are known to generate macro-particles within the plasma beam. These macro-particles negatively impact the quality of the coatings obtained and hence it is desirable to reduce the amount of macro-particles present in the plasma beam which ultimately coats the surface of the substrates.

Known methods of filtering macro-particles from the plasma beam have been taught in the art. For example, in one of the known methods, the plasma beam is steered through a gradual gentle bend of a duct in attempt to filter off macro-particles from the plasma beam. Another known method involves steering the plasma beam through at least two different gradual bends, both of which are present in different planes, also in attempt to remove macro-particles from the plasma beam. In all of these known methods, the bends used are gradual and gentle to allow a smooth transition of directions for the plasma beam to travel from the source to the substrate. While these methods do to some extent remove a percentage of macro-particles from the plasma beam reaching the substrate, all of these methods are still far from producing the desired low levels of macro-particles in the resultant coatings required in certain macro-particle-sensitive applications.

For example, in some applications, such as in the manufacture of hard disk drives, the internal components must be clean and substantially free from macro-particles inside the hard disk drive casing environment, to avoid compromising on the functioning of the hard disk drive. Thus, at the time of assembly, each of the components used to assemble the hard disk drive must be very clean and substantially free from macro-particles disposed thereon which may interfere with eventual hard disk drive operation. Accordingly, in applications such as coating of the hard disk components, it is desirable to reduce the amount of macro-particles present in these coatings to a level of less than 2 macro-particles (of sizes 0.2 microns or larger) per cm² of substrate. However, as mentioned above, none of the known arc deposition techniques are capable of achieving this desired result and accordingly cannot be effectively used to coat hard disk components.

Hence, there is a need to provide a filter for use in arc deposition techniques that overcomes or at least ameliorates one or more of the disadvantages described above.

There is also a need to provide an arc deposition apparatus and a method for removing macro-particles from a plasma beam that overcomes or at least ameliorates one or more of the disadvantages described above.

### SUMMARY

According to a first aspect, there is provided a filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion, and wherein said inlet plane and outlet plane are disposed at an offset angle from each other.

The disclosed filter has a three-dimensional configuration, wherein the inlet and outlet are separated by an intermediate portion containing a first bend at more than 90 degrees and wherein the inlet and outlet are not disposed on the same plane as each other.

Advantageously, the sharp change in direction of the intermediate portion causes the incident plasma beam to deviate at an angle of more than 90°, such that the macro-particles travelling in the incident direction and having a higher inertia than the rest of the ions in the plasma beam are removed. Further, the change in direction of the inlet plane and outlet plane at an offset angle also causes the plasma beam to deviate, thereby removing macro-particles travelling along the inlet plane.

Accordingly, the macro-particles are advantageously removed by both the bend of the intermediate portion and also by the bend between the inlet and intermediate portion and the bend between the intermediate portion and outlet portion as the plasma beam travels through the bends on different planes, thereby increasing the removal of macro-particles relative to a filter which contains a single bend or indeed a double bend that is disposed on the same plane between the inlet and outlet. Hence, the disclosed filter provides a high efficiency of macro-particle removal relative to single or double bend filters in which the filter duct is disposed on a common plane.

Further, the overall change in angles between the incident plasma beam and the emergent plasma beam is advantageously spread over the bends in different planes. Accordingly, the angle of the bend between the inlet portion and intermediate portion, the angle of the bend in the intermediate portion, and the angle of the bend between the intermediate portion and outlet portion is not overly pronounced. This is advantageous because the disclosed filter does not remove the desirable ions in the plasma beam at the same rate as the undesirable larger macro-particles such that the coating may be achieved at a faster rate, with fewer macro-particles per cm² of coating and with higher efficiency relative to a filter having consecutive bends that are on the same plane or a filter having only one pronounced bend angle. Advantageously, this reduces the utilization of the target arc source for preparing the coating, thereby reducing costs.

It has also been surprisingly observed that when the intermediate portion is configured to deviate the incident direction to the emergent direction at an angle of more than 90°, a large amount of macro-particles can be removed from the plasma beam to achieve a coating having less than 10 macro-particles (of diameter 0.2 microns or larger) per cm² of coating. Advantageously, the configuration of the bended duct comprising the intermediate portion connected at one end to the inlet portion and at another opposite end to the outlet portion allows a sharp change of direction, thus preventing the majority of the macro-particles, which have a larger inertia than the rest of the ions of the plasma beam, to follow the change in direction. More advantageously, the plasma beam that has passed through said intermediate portion emerging at the emergent direction is substantially free from macro-particles.

In one embodiment, the intermediate portion is being configured to deviate the incident direction to the emergent direction at an angle of from more than 90° to less than 180°. In one embodiment, the inlet portion and the outlet portion are in the same plane.

In one embodiment, the offset angle between the inlet plane and outlet plane is more than 20°. In another embodiment, the offset angle between the inlet plane and outlet plane is between 20° to 60° and preferably between 30° to 45°.

In another embodiment, the inlet portion further comprises an upstream portion connected at one end to the intermediate portion for passing said plasma beam from an arc source to said intermediate portion. The upstream portion and the inlet portion may provide a continuous path from an arc source to the intermediate portion and subsequently to the outlet portion. The upstream portion may be configured to deviate the direction of the plasma beam from the arc source to the incident direction toward said intermediate portion at an angle of less than 90°. In one embodiment, the upstream portion is configured to prevent at least some macro-particles that have been filtered by the intermediate portion from reverting back into the arc source. Advantageously, due to such configuration, macro-particles that have not entered into the outlet portion will not fall directly back to the arc source and contaminate the arc source. Rather, the macro-particles may accumulate at the upstream portion. More advantageously, the upstream portion provides a relatively gradual change in direction of the plasma beam from the arc source to the incident direction toward said intermediate portion, minimizing unnecessary loss of plasma ions present in the plasma beam after passing through said upstream portion.

In one embodiment, the intermediate portion comprises a first extended part for allowing macro-particles to travel along said incident direction to the first extended part. The longitudinal axis of the first extended part may be substantially parallel to the longitudinal axis of the inlet portion. Accordingly, the first extended part allows macro-particles that has not passed to the outlet portion to pass through to the first extended part and may be for example be removed by an additional removing unit attached to the first extended part. Even more advantageously, the first extended part may provide access to the inlet portion and intermediate portion for cleaning purposes or for inclusion of accessories such as baffles within the duct.

In one embodiment, the intermediate portion further comprises a second extended part that has a longitudinal axis which is substantially parallel to the longitudinal axis of the outlet portion. Advantageously, the second extended part may provide access to the intermediate portion and the outlet portion for cleaning purposes or for inclusion of accessories such as baffles within the duct.

In one embodiment, longitudinal axes of the inlet portion, first extended part, outlet portion and second extended part intersect at a single point. The presence of such configuration provides relative manufacturing ease, that is, such configuration of the inlet portion, first extended part, outlet portion and second extended part together makes manufacturing easier as compared to configurations such as those without the presence of the first and second extended parts, therefore reducing manufacturing costs.

In one embodiment, the outlet portion further comprises a downstream portion connected at one end to the intermediate portion for passing said plasma beam from said intermediate portion to a substrate. In one embodiment, the downstream portion is configured to provide a continuous path from the intermediate portion to said substrate. Advantageously, the downstream portion provides a connecting conduit for connecting the outlet portion with a substrate that is to be coated.

In one embodiment, the offset angle between the inlet plane of the inlet portion comprising the upstream portion and the outlet plane of the outlet portion comprising the downstream portion is more than 20°. In another embodiment, the offset angle between the inlet plane and outlet plane is between 20° to 60° and preferably between 30° to 45°.

The downstream portion may be configured to deviate the direction of the plasma beam from the emergent direction to a direction toward said substrate at an angle of less than 90°. The downstream portion may be configured to further filter at least some remaining macro-particles that have not been filtered by the intermediate portion and thereby prevent them passing downstream to the substrate. Advantageously, due to such configuration, the downstream portion provides a relatively gradual change in direction from the emergent direction to a direction toward said substrate, minimizing unnecessary loss of plasma ions present in the plasma beam after passing through said downstream portion whilst at the same time filtering off macro-particles that have managed to enter the outlet portion.

According to a second aspect, there is provided an arc deposition apparatus for coating a substrate, the apparatus comprising an arc source for producing a plasma beam; a filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion, and wherein said inlet plane and outlet plane are disposed at an offset angle from each other; and a magnetic field source for providing a magnetic field to steer the plasma beam from the incident direction to the emergent direction.

The magnetic field not only steers the plasma beam from the incident direction to the emergent direction on an x-y axis in one plane, the magnetic field also causes the plasma beam to drift from one plane to another plane along an x-y-z axis, such that the plasma beam is steered in a three-dimensional fashion. Accordingly, the inlet plane and the outlet plane of the disclosed filter are advantageously offset in a direction that follows the three-dimensional bend of the plasma beam so that the drift caused by the magnetic field may be compensated.

Hence, the disclosed arc deposition apparatus suffers minimal loss of desirable ions in the plasma beam and the throughput of the arc deposition apparatus may be increased by about one to two fold in the utilization of the target arc source. Advantageously, as the configuration of the filter follows the bend of the plasma beam, the plasma may be carried efficiently to the substrate.

Further, as the plasma beam goes through the bends of the disclosed filter, the macro-particles in the plasma beam may be efficiently removed.

Advantageously, the arc deposition apparatus of the second aspect is able to produce coatings that are substantially free from macro-particles. In one embodiment, the arc deposition apparatus of the second aspect produces coating that has less than 10 macro-particles per cm² of coating, less than 8 macro-particles per cm² of coating, less than 6 macro-particles per cm² of coating, less than 4 macro-particles per cm² of coating, less than 2 macro-particles per cm² of coating, or less than 1.8 macro-particles per cm² of coating, and wherein the macro-particles are 0.2 microns or larger.

The bended duct of the arc deposition apparatus may also additionally comprise the other additional portions and/or parts as described above. Accordingly, when the duct comprises the other portions described above, the upstream portion, inlet portion, intermediate portion, outlet portion and downstream portion may form a continuous path for allowing the plasma beam to travel from the arc source to the substrate.

According to a third aspect, there is provided a method of filtering macro-particles from a plasma beam, the method comprising the steps of generating a plasma beam containing macro-particles therein; passing the plasma beam containing macro-particles therein through a filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion and wherein said inlet plane and outlet plane are disposed at an offset angle from each other; and applying a magnetic field to the plasma beam to steer the plasma beam from the incident direction to the emergent direction so that the amount of macro-particles in said outlet portion is less relative to the amount of macro-particles in said inlet portion.

According to a fourth aspect, there is provided a method of producing a coating having less than 2 macro-particles of diameter 0.2 microns or larger per cm² of coating, the method comprising the steps of generating a plasma beam containing macro-particles therein; passing the plasma beam containing macro-particles therein through a filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion and wherein said inlet plane and outlet plane are disposed at an offset angle from each other; applying a magnetic field to the plasma beam to steer the plasma beam from the incident direction to the emergent direction so that the amount of macro-particles in said outlet portion is less relative to the amount of macro-particles in said inlet portion; and coating a substrate with the plasma beam that is travelling in the emergent direction to produce a coating having less than 2 macro-particles of diameter 0.2 microns or larger per cm² of coating.

According to a sixth aspect, there is provided the use of the filter, arc deposition apparatus and method disclosed herein to coat a hard disk component.

According to a seventh aspect, there is provided a duct for filtering macro-particles from a plasma beam, the duct comprising a portion having a continuous path for allowing the plasma beam to pass therethrough; and a single bend located within said portion configured to allow the plasma beam travelling towards the single bend in a first direction along the continuous path to, after passing said bend, travel in a second direction along the continuous path, wherein the second direction deviates from the first direction at an angle of more than 90°.

### DEFINITIONS

The following words and terms used herein shall have the meaning indicated:

The term “macro-particles” as used herein refers to particles having sizes or diameters of 200 nanometers and greater.

The term “deviate” used herein refers to a departure from a predetermined point of reference. For example, “deviate a first direction to second direction” refers to the departure of the second direction from the first direction. The angle of deviation should thus also be understood accordingly to mean the angle at which the direction changes from the first direction to the second direction.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### BRIEF DESCRIPTION OF THE DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1A shows a side view of one embodiment of the filter disclosed herein.

FIG. 1B shows a cross sectional view of the filter of FIG. 1A viewed from the end of element 114 and taken along the line A-A.

FIG. 1C shows an orthogonal view of the filter of FIG. 1A.

FIG. 1D shows a perspective view of the filter of FIG. 1A.

FIG. 1E shows the configuration of the magnetic field on the filter of FIG. 1C.

FIG. 2A shows a side view of another embodiment of the filter disclosed herein.

FIG. 2B shows a cross sectional view of the filter of FIG. 2A viewed from the end of element 214 and taken along the line A-A.

FIG. 2C shows the configuration of the magnetic field on the filter of FIG. 2A.

FIG. 3 shows a side view of yet another embodiment of the filter disclosed herein.

FIG. 4A shows a side view of one embodiment of the arc deposition apparatus disclosed herein.

FIG. 4B shows another view of the arc deposition apparatus of FIG. 4A viewed from the end of element 414.

### DETAILED DESCRIPTION OF DRAWINGS

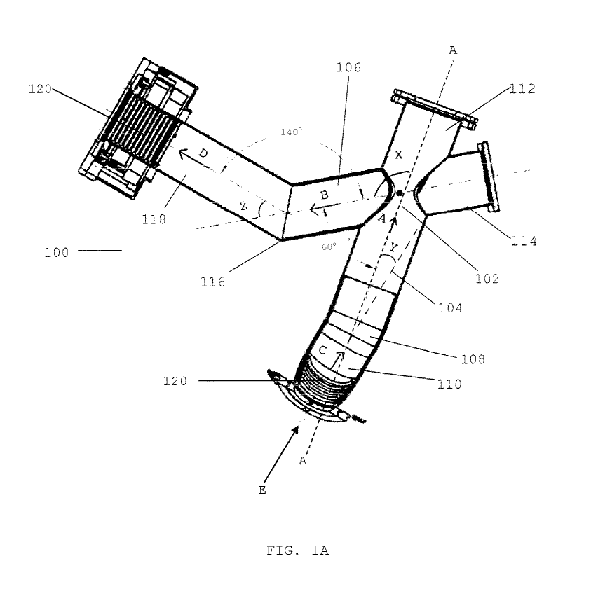

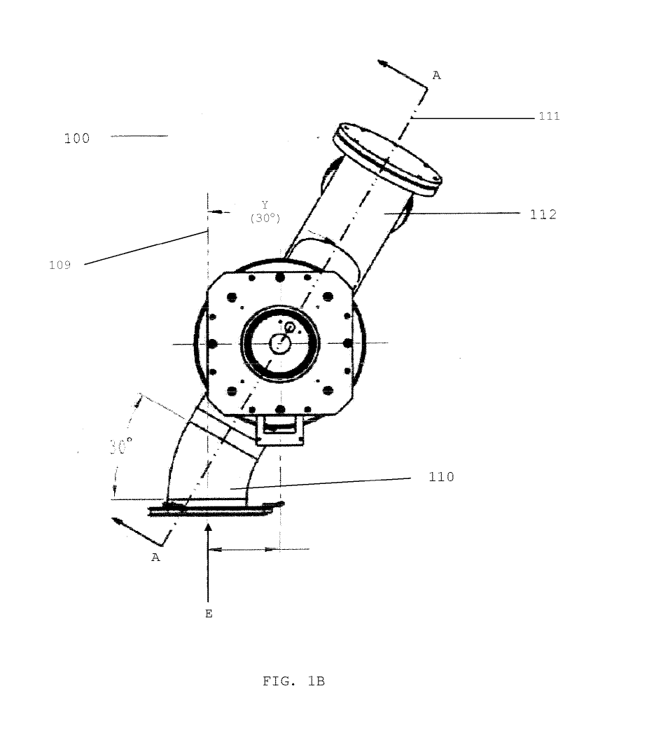

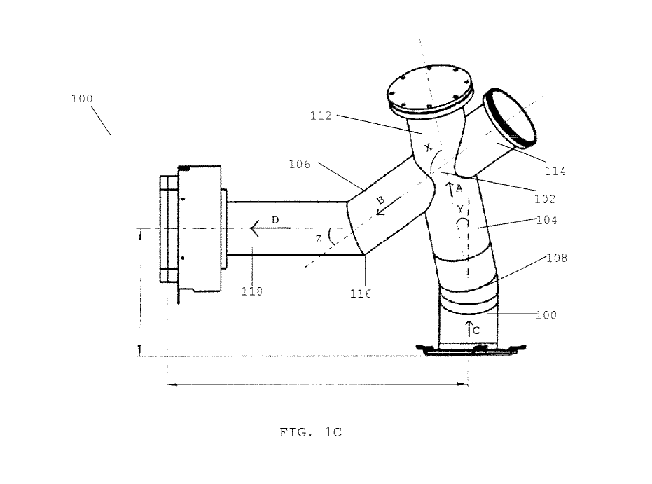

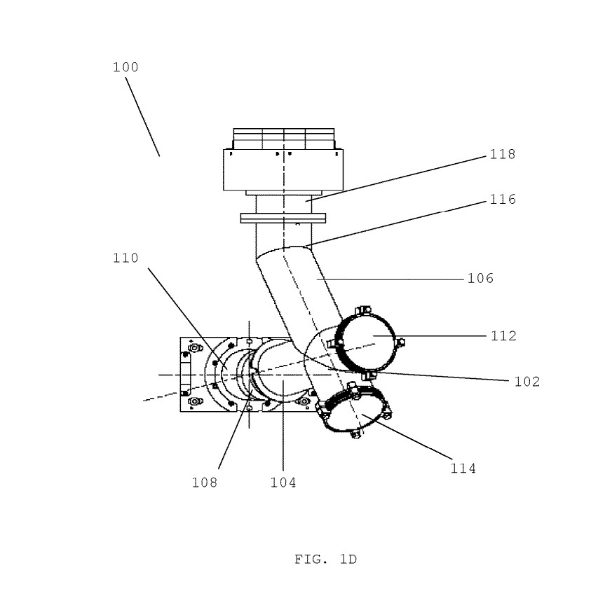

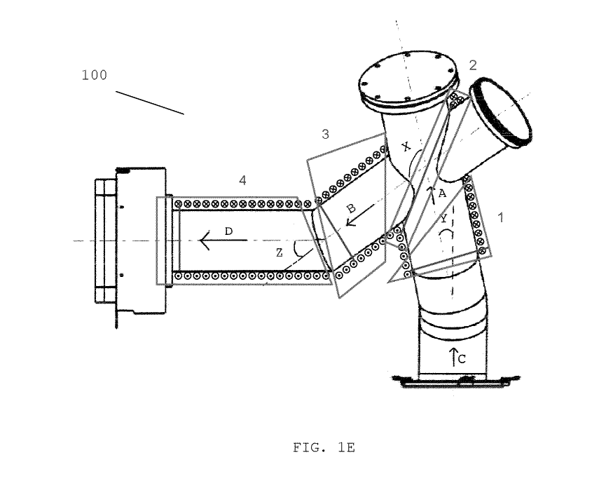

Referring to FIGS. 1A, 1B, 1C and 1D, there is shown one embodiment of a filter 100 for filtering macro-particles from a plasma beam disclosed herein. The filter 100 comprises a bended duct which has a first portion 102 defined between a second portion 104 and a third portion 106. The first portion 102 directs the plasma beam travelling in a first direction (arrow A) along the second portion 104 to a second direction (arrow B) along the third portion 106 such that the second direction (arrow B) deviates from the first direction (arrow A) at an angle of 120° (angle X).

The bended duct also comprises a fourth portion 108 defined between a fifth portion 110 and the second portion 104. As can be seen in the figures, the longitudinal axis of the fifth portion 110 is not parallel to the longitudinal axis of the second portion 104 and forms an angle of 30° (angle Y) with one another. The fourth portion 108 is configured to direct the plasma beam entering along arrow E and travelling in a third direction (arrow C) along the fifth portion 110 to the first direction (arrow A) along the second portion 104, such that the first direction (arrow A) deviates from the third direction (arrow C) at an angle of 30° (angle Y).

As can be seen in FIG. 1B which is a cross sectional view taken along line A-A, the plane 109 on which the fifth portion 110 is on and the plane 111 on which the second portion 104 is on are offset and forms an angle of 30° with one another. The three-dimensional configuration of filter 100 is also apparent from FIG. 1D.

The bended duct also comprises a sixth portion 112 connected to the first portion 102 for allowing macro-particles to travel from the second portion 104 the sixth portion 112. As can be seen in the figures, the longitudinal axis of the sixth portion 112 and the longitudinal axis of the second portion 104 are parallel to each other. More specifically, the sixth portion 112 and the second portion 104 share the same longitudinal axis.

The bended duct also comprises a seventh portion 114 connected to the first portion 102 where the longitudinal axis of the seventh portion 114 and the longitudinal axis of the third portion 106 are parallel to each other. More specifically, the seventh portion 114 and the third portion 106 share the same longitudinal axis. From the figures it can also be seen that the longitudinal axes of the second portion 104, third portion 106, sixth portion 112 and seventh portion 114 intersect at a single point.

The bended duct also comprises an eight portion 116 defined between the third portion 106 and a ninth portion 118. As can be seen in the figures, the longitudinal axis of the ninth portion 118 is not parallel to the longitudinal axis of the third portion 106 and forms an angle of 40° (angle Z) with one another. The eight portion 116 is configured to direct the plasma beam travelling in the second direction (arrow B) along the third portion 106 to a fourth direction (arrow D) along the ninth portion 118, such that the fourth direction (arrow D) deviates from the second direction (arrow B) at an angle of 40° (angle Z). Baffles 120 may also be present throughout the duct in different portions as required. The baffles 120 can be inserted to the different portions of the bended duct through the openings at the end of portions 112 and 114.

When in use, the plasma beam comprising macro-particles enters the filter 100 along arrow E and travels first in the third direction (arrow C) along fifth portion 110 on plane 109, passes the fourth portion 108, then travels in the first direction (arrow A) along second portion 104 on plane 111, passes first portion 102 before changing direction again to travel in the second direction (arrow B) along the third portion 106 also on plane 111. The first portion 102 results in a sharp change of direction (more than 90°) in the plasma beam. As the change of direction is sharp, macro-particles which have a larger mass and therefore a larger inertia than the positive ions in the plasma beam, continue their path towards the sixth portion 112, without substantial deviation in directions. Accordingly, a large amount of macro-particles are removed from the plasma beam resulting in the plasma beam travelling in the second direction (arrow B) along the third portion 106 having little or no macro-particles. The plasma beam then travels from the third portion 106, towards the eighth portion 116 and changes direction to the fourth direction (arrow D) and proceeds along the ninth portion 118. A substrate (not shown) placed at the end of the ninth portion 118 is then coated by the plasma beam which is substantially free from macro-particles. The ninth portion 118 serves as a connecting arm which directs the plasma beam from the third portion 106 to a fixed substrate. The eighth portion 116 may also remove any residual macro-particles that have managed to enter the third portion 106.

Referring to FIG. 1E, there is shown the configuration of the magnetic field on the filter of FIG. 1C. The magnetic field is required to steer the plasma beam from the first direction indicated by arrow A to second direction indicated by arrow B. The symbol indicates the direction of the magnetic field travelling out of the plane of the paper while the symbol \textcircled{x} indicates the direction of the magnetic field travelling into the plane of the paper. The magnetic field strength of the enclosed areas 1, 2, 3 and 4 is within 20 to 100 gauss.

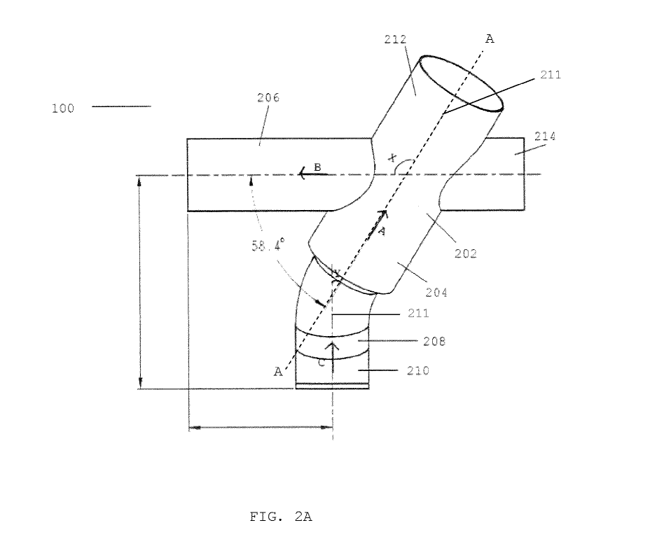

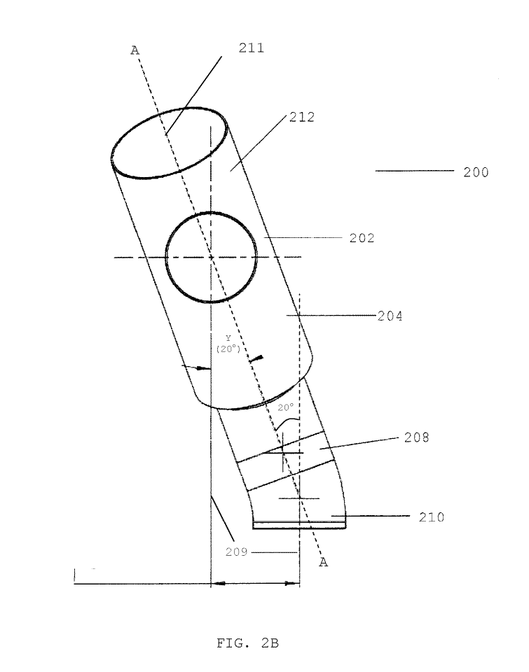

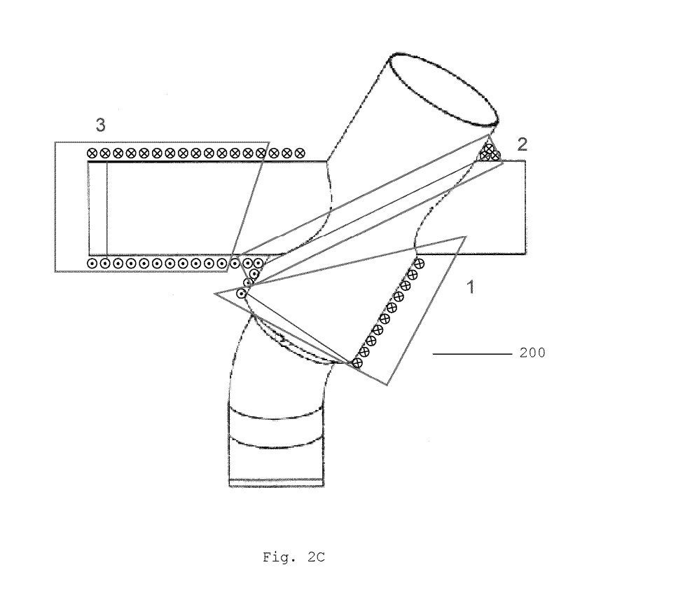

Referring to FIGS. 2A and 2B, there is shown another embodiment of a filter 200 for filtering macro-particles from a plasma beam disclosed herein. The filter 200 comprises a bended duct which has a first portion 202 defined between a second portion 204 and a third portion 206. The first portion 202 directs the plasma beam travelling in a first direction (arrow A) along the second portion 204 to a second direction (arrow B) along the third portion 206 such that the second direction (arrow B) deviates from the first direction (arrow A) at an angle of 121.6° (angle X).

The bended duct also comprises a fourth portion 208 defined between a fifth portion 210 and the second portion 204. As can be seen in the figures, the longitudinal axis of the fifth portion 210 lying on plane 209 is offset to the longitudinal axis of the second portion 204 lying on plane 211 and forms an angle of 20° (angle Y) with one another. The fourth portion 208 is configured to direct the plasma beam travelling in a third direction (arrow C) along the fifth portion 210 to the first direction (arrow A) along the second portion 204, such that the first direction (arrow A) deviates from the third direction (arrow C) at an angle of 20° (angle Y).

As can be seen in FIG. 2B, the three-dimensional configuration of filter 200 is apparent. The plane 209 on which the fifth portion 210 is on and the plane 211 on which the second portion 204 is on is offset and forms an angle of 20° with one another.

The bended duct also comprises a sixth portion 212 connected to the first portion 202 for allowing macro-particles to travel from the second portion 204 the sixth portion 212. As can be seen in the figures, the longitudinal axis of the sixth portion 212 and the longitudinal axis of the second portion 204 are parallel to each other. More specifically, the sixth portion 212 and the second portion 204 share the same longitudinal axis.

The bended duct also comprises a seventh portion 214 connected to the first portion 202 where the longitudinal axis of the seventh portion 214 and the longitudinal axis of the third portion 206 are parallel to each other. More specifically, the seventh portion 214 and the third portion 206 share the same longitudinal axis. From the figures it can also be seen that the longitudinal axes of the second portion 204, third portion 206, sixth portion 212 and seventh portion 214 intersect at a single point.

When in use, the plasma beam comprising macro-particles enters the filter along arrow E and travels first in the third direction (arrow C) along fifth portion 210 on plane 209, passes the fourth portion 208, then travels in the first direction (arrow A) along second portion 204 on plane 211, passes first portion 202 before changing direction again to travel in the second direction (arrow B) along the third portion 206 also on plane 211. The first portion 202 results in a sharp change of direction (more than 90°) in the plasma beam. As the change of direction is sharp, macro-particles which have a larger mass and therefore a larger inertia than the positive ions in the plasma beam, continue their path towards the sixth portion 212, without substantial deviation in directions. Accordingly, a large amount of macro-particles are removed from the plasma beam resulting in the plasma beam travelling in the second direction (arrow B) along the third portion 206 having little or no macro-particles.

Referring to FIG. 2C, there is shown the configuration of the magnetic field on the filter of FIG. 2A. The magnetic field is required to steer the plasma beam from the first direction indicated by arrow A of FIG. 2A to second direction indicated by arrow B of FIG. 2A. The symbol indicates the direction of the magnetic field travelling out of the plane of the paper while the symbol \textcircled{x} indicates the direction of the magnetic field travelling into the plane of the paper. The magnetic field strength of the enclosed areas 1, 2 and 3 is within 20 to 100 gauss.

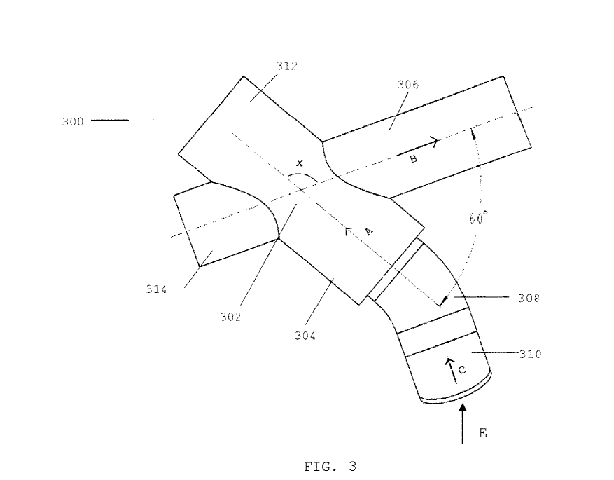

Referring now to FIG. 3, there is shown yet another embodiment of a filter 300 for filtering macro-particles from a plasma beam disclosed herein. The filter 300 comprises a bended duct which has a first portion 302 defined between a second portion 304 and a third portion 306. The first portion 302 directs the plasma beam travelling in a first direction (arrow A) along the second portion 304 to a second direction (arrow B) along the third portion 306 such that the second direction (arrow B) deviates from the first direction (arrow A) at an angle of 120° (angle X).

The bended duct also comprises a fourth portion 308 defined between a fifth portion 310 and the second portion 304. As can be seen in the figures, the longitudinal axis of the fifth portion 310 is not parallel to the longitudinal axis of the second portion 304 and forms an angle of less than 90° with one another. The fourth portion 308 is configured to direct the plasma beam travelling in a third direction (arrow C) along the fifth portion 310 to the first direction (arrow A) along the second portion 304, such that the first direction (arrow A) deviates from the third direction (arrow C) at an angle of less than 90°.

The bended duct also comprises a sixth portion 312 connected to the first portion 302 for allowing macro-particles to travel from the second portion 304 the sixth portion 312. As can be seen in the figures, the longitudinal axis of the sixth portion 312 and the longitudinal axis of the second portion 304 are parallel to each other. More specifically, the sixth portion 312 and the second portion 304 share the same longitudinal axis.

The bended duct also comprises a seventh portion 314 connected to the first portion 302 where the longitudinal axis of the seventh portion 314 and the longitudinal axis of the third portion 306 are parallel to each other. More specifically, the seventh portion 314 and the third portion 306 share the same longitudinal axis. From the figures it can also be seen that the longitudinal axes of the second portion 304, third portion 306, sixth portion 312 and seventh portion 314 intersect at a single point.

When in use, the plasma beam comprising macro-particles enters filter 300 along arrow E and travels first in the third direction (arrow C) along fifth portion 310, passes the fourth portion 308, then travels in the first direction (arrow A) along second portion 304, passes first portion 302 before changing direction again to travel in the second direction (arrow B) along the third portion 306. The first portion 202 results in a sharp change of direction (more than 90°) in the plasma beam. As the change of direction is sharp, macro-particles which have a larger mass and therefore a larger inertia than the positive ions in the plasma beam, continue their path towards the sixth portion 312, without substantial deviation in directions. Accordingly, a large amount of macro-particles are removed from the plasma beam resulting in the plasma beam travelling in the second direction (arrow B) along the third portion 306 having little or no macro-particles.

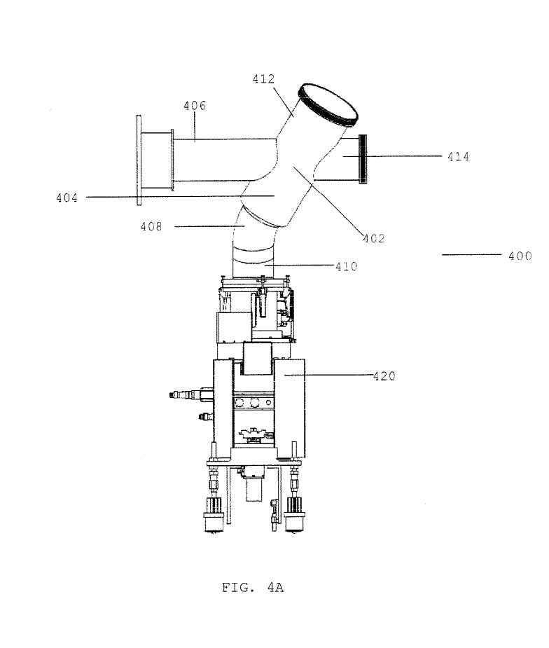

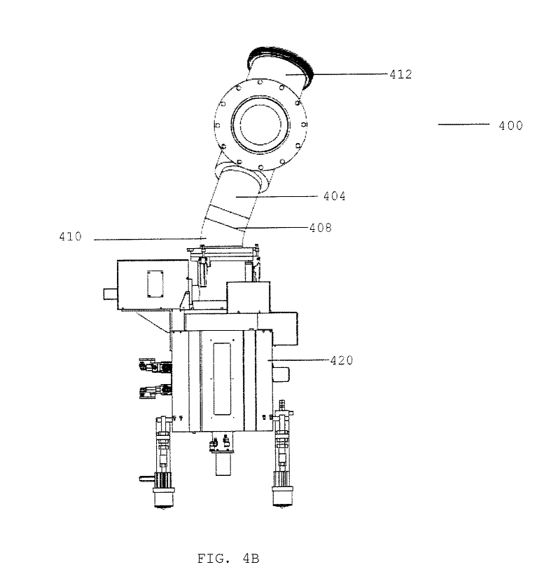

Referring now to FIGS. 4A and 4B, there is shown one embodiment of an arc deposition apparatus 400 disclosed herein. The arc deposition apparatus also comprises a filter having a bended duct which is structurally similar as those described above and based on similar working principles. Reference numerals 402, 404, 406, 408, 410, 412 and 414 correspond respectively to the first portion, the second portion, the third portion, the fourth portion, the fifth portion, the sixth portion and the seventh portion. The fifth portion 410 is directly attached to a cathodic arc source 420 for generation of a plasma beam containing positive ions. The cathodic arc source 420 used may be one which is commonly used in the art. Examples of which are disclosed in WO 96/26531 and U.S. Pat. No. 6,736,949 both of which are incorporated herein by reference.

Applications

The presently disclosed filter, arc deposition apparatus and methods are simple yet effective for removing a large amount of macro-particles from a plasma beam. Advantageously, the presently disclosed filter, arc deposition apparatus and methods are capable of producing coating having less than 1.8 macro-particles of diameter 0.2 microns or larger per cm² of coating. Accordingly, the disclosed filter, arc deposition apparatus and methods may be used for ultra clean applications such as for the coating hard disk components where the presence of a high number of macro-particles cannot be tolerated. The arc deposition apparatus and methods are also capable of having a relatively high deposition rate as compared to other coating methods and also capable of producing thin coating films of less than 2 nm. Such characteristics are especially beneficial for use in the coating of hard disk components on an industrial scale.

Furthermore, as the working range of the arc current used for the disclosed filter, arc deposition apparatus and methods is typically between about 50 to about 80 amps, which is higher than the typical working ranges of currently known filters (about 20 to 35 amps), there is a large improvement in arc stability as compared to conventional filters, arc deposition apparatuses and arc deposition methods.

While reasonable efforts have been employed to describe equivalent embodiments of the present invention, it will be apparent to the person skilled in the art after reading the foregoing disclosure, that various other modifications and adaptations of the invention may be made therein without departing from the spirit and scope of the invention and it is intended that all such modifications and adaptations come within the scope of the appended claims.

### DETAILED DESCRIPTION OF THE PREFERRED EMBODIMENTS

Exemplary, non-limiting embodiments of a filter for filtering macro-particles from a plasma beam, an arc deposition apparatus and a method for filtering macro-particles from a plasma beam, will now be disclosed.

There is provided a filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion, and wherein said inlet plane and outlet plane are disposed at an offset angle from each other. The emergent direction may deviate from the incident direction at an angle X selected from group consisting of 90°<X<180°, 100°≦X≦170°, 110°≦X≦160°, 120°≦X≦150° and 130°≦X≦140°. In one embodiment, the angle X is about 135°. In another embodiment, the angle X is selected from the group consisting of 149°, 120° and 160°. In yet another embodiment, the angle X is about 120°.

In one embodiment, the inlet portion comprises an upstream portion connected at one end to the intermediate portion for passing said plasma beam from an arc source to said intermediate portion. The upstream portion may be configured to deviate the direction of the plasma beam from the arc source to the incident direction of said intermediate portion at an angle of less than 90°. The incident direction may deviate from the direction of the plasma beam from the arc source at an angle Y selected from the group consisting of 0°<Y<90°, 10°≦Y≦80°, 20°≦Y≦70°, 30°≦Y≦60° and 40°≦Y≦50°. In one embodiment, the angle Y is about 45°.

In the embodiment where the inlet portion comprises the upstream portion, the offset angle A between the inlet plane of the inlet portion comprising the upstream portion and the outlet plane may be offset. In one embodiment, the offset angle A between the planes is more than about 20°. In another embodiment, the offset angle A is selected from the group consisting of 20°<A<90°, 20°<A<80°, 20°<A<70°, 20°<A≦60°, 30°≦A≦60°, 30°≦A≦50° and 30°≦A≦45°. In one embodiment, the angle A is between about 30° and about 45°.

In one embodiment, the intermediate portion comprises a first extended part for allowing macro-particles to travel along said incident direction to the extended part. The longitudinal axis of the first extended part may be substantially parallel to the longitudinal axis of the inlet portion. In one embodiment, the macro-particles can travel in a straight line path from the inlet portion to the first extended part. The first extended part may have a closed end which may be optionally opened when desired for access to the intermediate portion and the inlet portion.

In one embodiment, the intermediate portion further comprises a second extended part that has a longitudinal axis which is substantially parallel to the longitudinal axis of the outlet portion. In one embodiment, a straight line path exists from the second extended part to the outlet portion. The second extended part may have a closed end which may be optionally opened when desired for access to the intermediate portion and the outlet portion.

In one embodiment, the longitudinal axes of the inlet portion, first extended part, outlet portion and second extended part intersect at a single point, such that a “X” shaped bended duct is achieved. In another embodiment, where only the inlet portion, intermediate portion, and outlet portion are present, the longitudinal axes of the inlet portion and outlet portion intersect at a single point to form a “>” shaped bended duct. In another embodiment, where only the inlet portion, first extended part, intermediate portion and outlet portion are present, the longitudinal axes of the inlet portion, first extended part, and outlet portion intersect at a single point to form a “Y” shaped duct. It should be noted that the “X”, “>” and “Y” symbols are provided herein only for general illustrative purposes and should in no way serve to limit or define the angles between the lines shown in the “X”, “>” and “Y” symbols.

In one embodiment, the outlet portion further comprises a downstream portion connected at one end to the intermediate portion for passing said plasma beam from said intermediate portion to a substrate. The downstream portion may be configured to deviate the direction of the plasma beam from the emergent direction to a direction toward said substrate at an angle Z of less than 90°. The angle Z may be selected from group consisting of 0°<Z<90°, 10°≦Z≦80°, 20°≦Z≦70°, 30°≦Z≦60° and 40°≦Z≦50°. In one embodiment, the angle Z is about 45°.

In the embodiment where the outlet portion comprises the downstream portion, the offset angle B between the inlet plane and the outlet plane of the outlet portion comprising the downstream portion may be offset. In one embodiment, the offset angle B between the planes is more than about 20°. In another embodiment, the offset angle B is selected from the group consisting of 20°<B<90°, 20°<B<80°, 20°<B<70°, 20°<B≦60°, 30°≦B≦60°, 30°≦B≦50° and 30°≦B≦45°. In one embodiment, the angle B is between about 30° and about 45°.

In the embodiment where the inlet portion comprises the upstream portion and the outlet portion comprises the downstream portion, the offset angle between the inlet plane of the inlet portion comprising the upstream portion and the outlet plane of the outlet portion comprising the downstream portion is more than 20°. In another embodiment, the offset angle between the inlet plane and outlet plane is between 20° to 60° and preferably between 30° to 45°.

The bended duct described herein may be toroidal. In one embodiment, there may be no single line of sight from the inlet portion to the outlet portion. In one embodiment, the plane on which the plasma beam is travelling from the arc deposition source to the upstream portion and the plane on which the plasma beam is travelling from the inlet portion to outlet portion are not parallel. In another embodiment, the plasma beam travelling from the inlet portion to the outlet portion and the plasma beam travelling from the downstream portion to the substrate is on the same plane. The upstream portion, inlet portion, intermediate portion, outlet portion and downstream portion may have substantially the same diameters or entirely different diameters. The diameters of the upstream portion, inlet portion, intermediate portion, outlet portion and downstream portion of the bended duct may be independent selected from the group consisting of diameter from the range of from about 50 mm to about 250 mm, about 60 mm to about 240 mm, about 70 mm to about 230 mm, about 80 mm to about 220 mm, about 90 mm to about 210 mm, about 100 mm to about 200 mm, about 120 mm to about 180 mm, about 140 mm to about 160 mm or about 140 mm to about 150 mm.

The bended duct and its individual portions may be made up of any material that has little or no magnetic field shielding effects. Preferably, the bended duct and its individual portions are made up of materials that are substantially inert to ionization to avoid contamination of the plasma beam during arc deposition. The bended duct and its individual portions may be made up materials that are able to sustain vacuum conditions such as Al, Cu and other metals or alloys thereof. In one embodiment, the bended duct and its individual portions are made up of stainless steel.

A liner may also be present within the bended duct. In one embodiment, the liner is removable for cleaning purposes and to prevent long term deposit from building up on the duct walls. The liner maybe positively biased, typically to between about 10V to about 30V to create a repulsion between the liner and the positive ions in the plasma beam and thereby increases the flow of plasma through the bended duct. The liner may also be adapted further to increase filtering of macro-particles from the plasma beam. In one embodiment, the liner is made-up of a series of rings having flanges that project outwards into the interior of the duct and are angled backwards and towards the target. The liner may be made of a series of rings linked, alternately around their peripheries, for example at 12 o'clock and 6 o'clock, and then at 3 o'clock and 9 o'clock. In one embodiment, the liner is flexible and suitable to be pushed into the duct and around duct bends.

There is also provided an arc deposition apparatus for coating a substrate, the apparatus comprising an arc source for producing a plasma beam; a filter defined above; and a magnetic field source for providing a magnetic field to steer the plasma beam from the incident direction to the emergent direction.

The disclosed arc deposition apparatus may have an increased throughput or target utilization of the arc source of about one to two fold. This is advantageous because the target arc source may be chromium which is expensive or graphite. Accordingly, the uniquely disclosed bend is more cost effective.

The plasma beam can be guided by a curvi-linear magnetic field along the length of the duct. Alternatively, the plasma beam may be guided by a crossed electric and magnetic field. Coils may also be provided on the bended duct to provide the magnetic steering field for the plasma beam. These coils may be optionally water cooled. Alternatively, permanent magnets may also be used. The magnetic field strength applied may be in the range of from about 20 gauss to about 100 gauss, from about 30 gauss to about 90 gauss, from about 30 gauss to about 80 gauss, from about 30 gauss to about 70 gauss, from about 40 gauss to about 60 gauss, from about 30 gauss to about 60 gauss or from about 30 gauss to about 50 gauss.

In one embodiment the arc source, filter and substrate are under vacuum conditions. The arc deposition apparatus may also further comprise a vacuum chamber fluidly sealing the arc source, filter and substrate. A vacuum means may also be provided to create vacuum conditions in the arc deposition apparatus. The vacuum pressure created may be in the order of 10⁻⁶ Torr to 10⁻⁵ Torr.

The arc deposition apparatus may further comprise a substrate holder for holding the substrate. In one embodiment, where the arc deposition apparatus is a cathodic arc deposition apparatus, there may also be a means for cooling the cathode. In another embodiment, the arc deposition apparatus further comprises means for applying a positive bias to the filter duct.

An arc power supply may be connected to the source and provides power for both the arc and for arc striking (ignition), achieved using a moveable striker located insider the vacuum chamber. In one embodiment, the arc current is about from 20 to about 200 amps, from 30 to about 150 amps, from 40 to about 100 amps or from 50 to about 80 amps and variation in the current varies the rate of deposition of ions on the substrate. Arc voltage is also material dependent and for any given arc source set up does not vary outside a fairly narrow range. With a carbon target the arc voltage is typically about 29V.

In one embodiment, the apparatus further comprises baffles located at or close to walls of the vacuum chamber of the apparatus and between the cathode target and the plasma duct to reduce indiscriminate direction of travel of the macro-particles and ions in the plasma beam. In one embodiment, the baffles are non-conducting, e.g. made of ceramic or PTFE. The baffles may be non-metal, e.g. made of graphite or ceramic. In another embodiment, the baffles are removable for cleaning purposes.

This apparatus may also enable gas ionisation to occur in the arc. Accordingly, in one embodiment, a gas introducing means comprising a gas inlet is present in the vacuum chamber.

There is also provided a method of filtering macro-particles from a plasma beam, the method comprising the steps of generating a plasma beam containing macro-particles therein; passing the plasma beam containing macro-particles therein through a filter defined above; and applying a magnetic field to the plasma beam to steer the plasma beam from the incident direction to the emergent direction so that the amount of macro-particles in said outlet portion is less relative to the amount of macro-particles in said inlet portion.

In one embodiment, the filter, arc deposition apparatus and methods described herein is capable of producing a coating that has less than about 10 macro-particles per cm² of coating, less than about 8 macro-particles per cm² of coating, less than about 6 macro-particles per cm² of coating, less than about 4 macro-particles per cm² of coating, less than about 2 macro-particles per cm² of coating, or less than about 1.8 macro-particles per cm² of coating, and wherein the macro-particles are about 0.2 microns or larger, about 0.5 microns or larger, about 0.8 microns or larger, about 1 microns or larger, about 2 microns or larger, about 3 microns or larger, about 4 microns or larger, about 5 microns or larger, about 6 microns or larger, about 7 microns or larger, about 8 microns or larger, about 9 microns or larger, about 10 microns or larger. In one embodiment, the filter, arc deposition apparatus and method described herein is capable of producing a coating that has less than about 1.8 macro-particles per cm² of coating, wherein the macro-particles are about 0.2 microns or larger.

As a comparison, a known double bend filter without an intermediate portion configured to deviate the incident direction to the emergent direction at an angle of more than 90°, such as that disclosed in WO 96/26531, produces a coating that has about 10 times more macro-particles per cm² of coating, wherein the macro-particles are about 0.2 microns or larger.

1. A filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion, and wherein said inlet plane and outlet plane are disposed at an offset angle from each other.

2. (canceled)

3. The filter as claimed in claim 1, wherein the offset angle between the inlet plane and outlet plane is between 20° to 60°.

4. (canceled)

5. The filter as claimed in claim 1, wherein the intermediate portion is configured to deviate the incident direction to the emergent direction at an angle of from more than 90° to less than 180°.

6. (canceled)

7. The filter as claimed in claim 1, wherein the inlet portion comprises an upstream portion connected at one end to the intermediate portion for passing said plasma beam from an arc source to said intermediate portion.

8. The filter as claimed in claim 7, wherein said upstream portion is configured to deviate the direction of the plasma beam from the arc source to the incident direction of said intermediate portion at an angle of less than 90°.

9. The filter as claimed in claim 7, wherein said upstream portion is configured to prevent at least some macro-particles that have been filtered by the intermediate portion from reverting back into the arc source.

10.-12. (canceled)

13. The filter as claimed in claim 7, wherein the outlet portion further comprises a downstream portion connected at one end to the intermediate portion for passing said plasma beam from said intermediate portion to a substrate.

14. The filter as claimed in claim 13, wherein said downstream portion is configured to deviate the direction of the plasma beam from the emergent direction to a direction toward said substrate.

15. The filter as claimed in claim 13, wherein the downstream portion is configured to further filter at least some remaining macro-particles that have not been filtered by the intermediate portion and thereby prevent them passing downstream to the substrate.

16. An arc deposition apparatus for coating a substrate, the apparatus comprising:
an arc source for producing a plasma beam;
a filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion, and wherein said inlet plane and outlet plane are disposed at an offset angle from each other; and
a magnetic field source for providing a magnetic field to steer the plasma beam from the incident direction to the emergent direction.

17. The arc deposition apparatus as claimed in claim 16, wherein the offset angle between the inlet plane and outlet plane is more than 20°.

18. The arc deposition apparatus as claimed in claim 16, wherein the intermediate portion is being configured to deviate the incident direction to the emergent direction at an angle of from more than 90° to less than 180°.

19. (canceled)

20. The arc deposition apparatus as claimed in claim 16, wherein the inlet portion comprises an upstream portion connected at one end to the intermediate portion for passing said plasma beam from an arc source to said intermediate portion.

21. The arc deposition apparatus as claimed in claim 20, wherein said upstream portion is configured to deviate the direction of the plasma beam from the arc source to the incident direction of said intermediate portion at an angle of less than 90°.

22. The arc deposition apparatus as claimed in claim 20, wherein said upstream portion is configured to prevent at least some macro-particles that have been filtered by the intermediate portion from reverting back into the arc source.

23.-25. (canceled)

26. The arc deposition apparatus as claimed in claim 16, wherein the bended duct further comprises a downstream portion connected at one end to the outlet portion for passing said plasma beam from said outlet portion to a substrate.

27. The arc deposition apparatus as claimed in claim 26, wherein said downstream portion is configured to deviate the direction of the plasma beam from the emergent direction to a direction toward said substrate.

28. The arc deposition apparatus as claimed in claim 26, wherein the downstream portion is configured to further filter at least some remaining macro-particles that have not been filtered by the intermediate portion and thereby prevent them passing downstream to the substrate.

29. The arc deposition apparatus as claimed in claim 26, wherein the upstream portion, inlet portion, intermediate portion, outlet portion and downstream portion form a continuous path for allowing the plasma beam to travel from the arc source to the substrate.

30. A method of filtering macro-particles from a plasma beam, the method comprising the steps of:
generating a plasma beam containing macro-particles therein;
passing the plasma beam containing macro-particles therein through a filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion, and wherein said inlet plane and outlet plane are disposed at an offset angle from each other; and
applying a magnetic field to the plasma beam to steer the plasma beam from the incident direction to the emergent direction so that the amount of macro-particles in said outlet portion is less relative to the amount of macro-particles in said inlet portion.

31. A method of producing a coating having less than 2 macro-particles of diameter 0.2 microns or larger per cm² of coating, the method comprising the steps of:
generating a plasma beam containing macro-particles therein;
passing the plasma beam containing macro-particles therein through a filter for filtering macro-particles from a plasma beam, the filter comprising a bended duct for carriage of said plasma beam, the bended duct comprising an intermediate portion connected at one end to an inlet portion having a longitudinal axis disposed on an inlet plane and at another opposite end to an outlet portion having a longitudinal axis disposed on an outlet plane, said inlet portion allowing said plasma beam containing macro-particles to travel toward said intermediate portion in an incident direction and said outlet portion allowing said plasma beam to travel from said intermediate portion in an emergent direction, said intermediate portion being configured to deviate the incident direction to the emergent direction at an angle of more than 90° and thereby remove macro-particles from said plasma beam as it passes through said intermediate portion, and wherein said inlet plane and outlet plane are disposed at an offset angle from each other;
applying a magnetic field to the plasma beam to steer the plasma beam from the incident direction to the emergent direction so that the amount of macro-particles in said outlet portion is less relative to the amount of macro-particles in said inlet portion; and
coating a substrate with the plasma beam that is travelling in the emergent direction to produce a coating having less than 2 macro-particles of diameter 0.2 microns or larger per cm² of coating.

32. (canceled)
